(19) United States
(12) Patent Application Publication
(10) Pub. No.: US 2015/0220338 A1
(43) Pub. Date: Aug. 6, 2015

(54) SOFTWARE POLLING ELISION WITH RESTRICTED TRANSACTIONAL MEMORY

(71) Applicants: Lejun ZHU, Shanghai (CN); INTEL CORPORATION, Santa Clara, CA (US)

(72) Inventor: Lejun Zhu, Shanghai (CN)

(21) Appl. No.: 14/127,988

(22) PCT Filed: Jun. 18, 2013
(86) PCT No.: PCT/CN13/77373

§ 371 Date: Dec. 20, 2013

(51) Int. Cl. G06F 9/30; G06F 9/46; G06F 9/445

(52) U.S. Cl. CPC G06F 9/3009; G06F 9/3004; G06F 9/44552; G06F 9/44557; G06F 9/467

(57) ABSTRACT

Generally, this disclosure provides systems, devices, methods and computer readable media for software polling elision with restricted transactional memory. The device may include a restricted transactional memory (RTM) processor configured to monitor a region associated with a transaction and to enable an abort of the transaction, wherein the abort nullifies modifications to the region, the modifications associated with processing within the transaction prior to the abort. The device may also include a code module configured to: produce a first request; send the first request to an external processing entity; enter the transaction; produce a second request; commit the transaction in response to a completion indication from the external processing entity; and abort the transaction in response to a non-completion indication from the external entity.

### FIELD

The present disclosure relates to software polling elision, and more particularly, to software polling elision with restricted transactional memory.

### BACKGROUND

Computing systems often have multiple processors or processing cores over which a given workload may be distributed to increase computational throughput. Multiple threads or processes may execute in parallel on each of the processor cores and may share common regions of memory. A thread on one core may generate a processing request that is sent to a thread on another core where the request is to be fulfilled. The requesting thread may sometimes be blocked from performing further processing, for example generating a second request, until the first request is fulfilled. This may occur, for example, in situations where an error or unexpected result from the processing of the first request could invalidate subsequent processing by the requesting thread.

The requesting thread may resort to polling in order to determine when processing can be resumed. This can increase latency and reduce processing efficiency. As computing systems scale upwards in size, to greater numbers of cores and threads executing in parallel, the delays associated with polling may degrade performance and impede scalability.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one exemplary embodiment consistent with the present disclosure;

FIG. 2 illustrates a block diagram of one exemplary embodiment consistent with the present disclosure;

FIG. 3 illustrates a flowchart of operations of one exemplary embodiment consistent with the present disclosure;

FIG. 4 illustrates a timing diagram of one exemplary embodiment consistent with the present disclosure; and

FIG. 5 illustrates a flowchart of operations of another exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems, devices, methods and computer readable media for software polling elision using restricted transactional memory (RTM). Software polling elision (e.g., the elimination or reduction of software polling) may be accomplished with RTM monitoring, as will be explained below. Software polling elision avoids the latency that may be incurred when a first thread makes a request to a second thread, for example on another processor, but is then blocked from performing certain types of additional processing until the second thread fulfills the request, which may be determined through polling. Polling typically consumes processor cycles which could otherwise be used to perform work. Polling elision may therefore improve system performance, particularly as the number of processors and parallel executing threads increases.

In some embodiments, hardware support for RTM monitoring may be provided to the processors or processing cores through an instruction set architecture extension. The extension may provide instructions to begin (or enter) a transaction region of code, to exit (or commit) the transaction region and to trigger and subsequently handle an abort of the transaction region. The RTM monitor may buffer the side effects of memory accesses, performed by code within the transaction region, until the transaction exits or commits. If the transaction aborts before committing, however, either explicitly or due to a memory object access conflict between threads, the buffered side effects are discarded (e.g., the transaction is rolled back or nullified) and alternative code may be executed to handle the abort condition. A thread may therefore accomplish polling elision by entering a transaction region after sending a request to another thread. The first thread may then perform further processing rather than waiting in a polling loop. If, for some reason, the request fails to complete, the transaction may be aborted and the post-request processing effects rolled back.

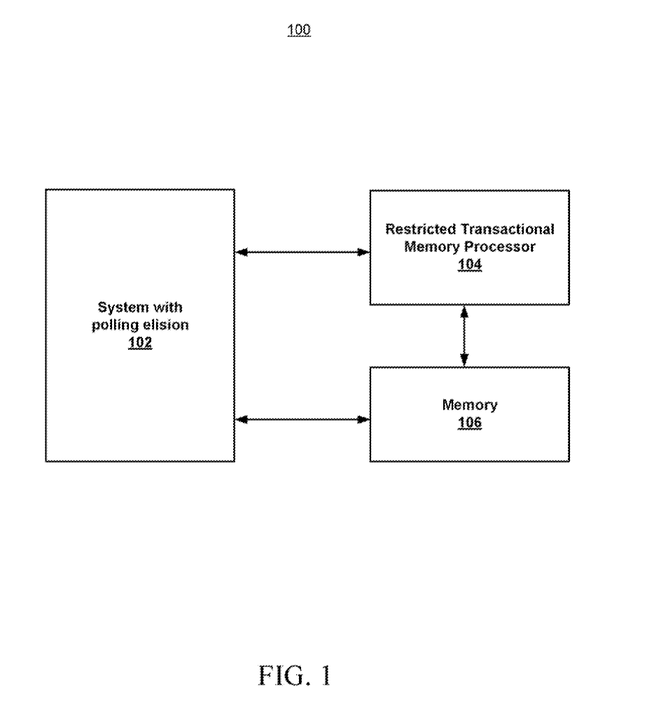

FIG. 1 illustrates a top level system diagram 100 of one exemplary embodiment consistent with the present disclosure. A system configured for polling elision 102 is shown to interact with a memory 106 which may be shared between multiple processors or processor cores that are included in system 102. Also shown in this figure is RTM processor 104 which may be configured to enable the creation of transaction regions within memory 106 and further configured to monitor, buffer and roll back (or nullify) modifications to memory objects within these transaction regions. This roll back capability may effectively restore the system to a state that is equivalent to the state the system would have been in if the processing in the transaction region had not occurred. Threads, or other processing entities, executing within system 102 may accomplish polling elision through the use of transaction regions and RTM monitoring, as will be explained in greater detail below.

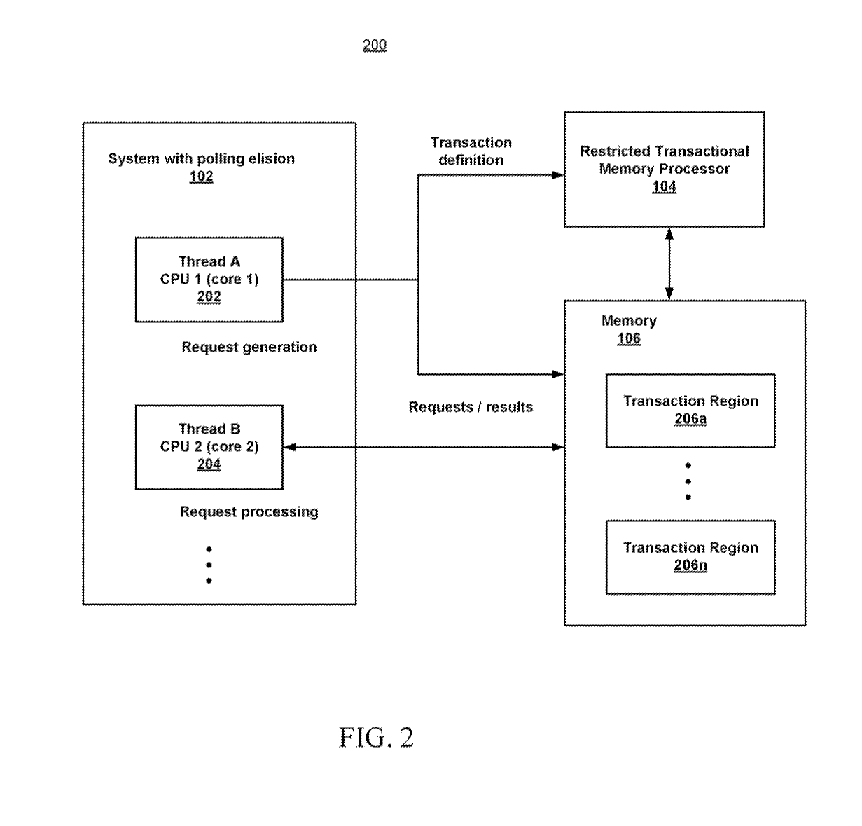

FIG. 2 illustrates a block diagram 200 of one exemplary embodiment consistent with the present disclosure. The system 102, configured for polling elision, is shown to include multiple central processing units (CPUs), for example CPU 1 202, CPU 2 204, etc. In some embodiments the CPUs may be processing cores that are included in a single integrated circuit or other suitable chip package. Each CPU may execute one or more threads (or processes, tasks, code modules or other processing entities) in parallel, such that a workload is distributed for increased efficiency. For example, CPU 1 may be executing thread A and CPU 2 may be executing thread B. During the performance of a task, thread A may have occasion to generate one or more requests that need to be performed or fulfilled by thread B. The requests and the associated results may pass through regions of memory 106 and these regions may include transaction regions 206a, . . . 206n.

RTM processor 104 may be configured to enable the threads 202, 204 to define transaction regions 206a, 206n. RTM processor 104 may provide hardware support, for example an instruction set architecture extension, that enables a region of code to begin (or enter) a transaction region, to exit (or commit) the transaction and to trigger and handle an abort of the transaction. In some embodiments, the RTM processor 104 maintains a read-set and/or a write-set of memory objects that are accessed by code executing within a transaction region. These memory objects are monitored and the RTM processor 104 may buffer the side effects of memory accesses to these objects (e.g., modifications), performed by code within the transaction region, until the transaction exits or commits, at which time they become effective and visible to other threads. If the transaction aborts before committing, however, either explicitly or due to a memory object access conflict between threads, the buffered side effects are discarded (e.g., the transaction is rolled back) and alternative code may be executed to handle the abort condition.

Thread A 202, for example, may therefore accomplish polling elision by entering a transaction region 206a after sending a request to Thread B 204. Thread A may then perform further processing rather than waiting in a polling loop. If, for any reason, the request fails to complete, the transaction may be aborted and the post-request processing rolled back. If this occurs, polling may be used as a fallback position.

In some embodiments, one or more of the CPUs (e.g., CPU 1) may be a core processors while other CPUs (e.g., CPU 2) may be a network processor, a graphics processor, an I/O processor or any other type of auxiliary processing unit capable of accessing memory, directly or indirectly, that is included in a transaction region. Thus, for example, it may be the case that only one processor (or a subset of the processors) has RTM capabilities (i.e., the ability to execute instructions from the RTM instruction set architecture extension). That RTM-capable processor may define a transaction region, while the other non-RTM capable (or traditional) processors may simply access memory objects in the transaction region but nevertheless trigger RTM effects.

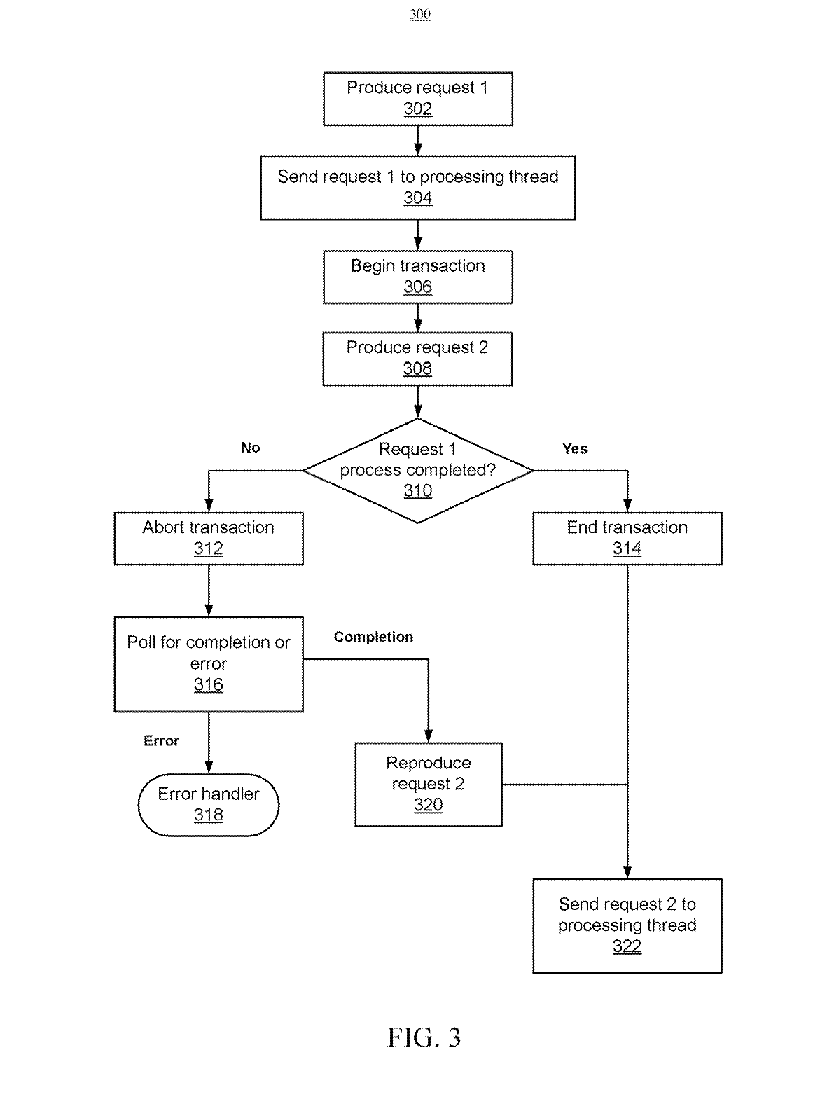

FIG. 3 illustrates a flowchart of operations 300 of one exemplary embodiment consistent with the present disclosure. At operation 302, a first request (request 1) is produced by a requesting thread, for example thread A on CPU 1 202. At operation 304, request 1 is sent to a processing thread, for example thread B on CPU 2 204. At operation 306, the requesting thread begins or enters a transaction region, for example 206a. At operation 308, the requesting thread performs addition processing that may depend on a successful completion of the first request. This may include, for example, the generation of a second request (request 2). The requesting thread may then, at operation 310, check to determine if request 1 has been completed.

If request 1 was completed, the transaction may be ended, at operation 314, thus committing any memory changes made during the transaction, and the next request (request 2) may be sent to the processing thread at operation 322. Since request 2 was generated while request 1 was being processed (i.e., in parallel) a computational efficiency may be achieved.

If request 1 was not completed, the transaction may be aborted, at operation 312, and a polling loop entered at operation 316. The polling may continue until a completion indication or an error indication is detected. If an error is reported, an error handler may be invoked, at operation 318. Otherwise, the new request (request 2) may be re-produced at operation 320, since the abort will have rolled back memory changes associated with the previous generation of request 2. The re-produced request is then sent again to the processing thread at operation 322.

An illustration of pseudo-code for thread A and thread B consistent with one exemplary embodiment is shown below. In this example, thread A (on CPU 1) produces a first request (request 1) and initializes a status variable to a “not done” state. The request 1 is sent to thread B along with a reference to (i.e., address of) the status variable. Thread A then enters a transaction region with a specified transaction abort handler. This may be accomplished on some processors, for example, with an XBEGIN instruction. Thread A then performs additional processing which may include the production of a second request (request 2). Meanwhile, thread B (on CPU 2), processes request 1 in parallel and sets the status variable to indicate either an “error” or a “done” state.

At a subsequent point in time, thread A checks the status variable to determine if thread B has completed request 1 by updating the status variable to “done.” This check may be performed, for example, when thread A has no further processing that can be performed until the result from request 1 is obtained, or it may be performed at any other suitable time. If the check indicates completion, thread A commits the transaction and exits the transaction region. The commit may be accomplished on some processors, for example, with an XEND instruction. After committing the transaction thread A proceeds to the code segment labeled “send_next,” where the status variable is reset to a “not done” state and the second request (request 2) is sent to thread B.

Alternatively, if the check does not indicate completion, thread A triggers an abort of the transaction which rolls back any effects of the processing, for example effects associated with the production of request 2. The abort may be accomplished on some processors, for example, with an XABORT instruction. The abort also causes thread A to execute the abort handler code segment. The abort handler executes a polling loop which waits for thread B completion, either “done” status or “error” status. In the event of an error, an error handler may be called, otherwise a new request 2 may be generated which is then re-sent to thread B for processing.

| | |
|---|---|
| // Thread A (CPU 1) | |
| produce_request(request1); | // produce first request |
| status = NOT_DONE; | |
| send_request(request1, &status); | // send first request to Thread B |
| XBEGIN(handle_abort); | // begin a transaction region |
| produce_request(request2); | // produce second request under |
| protection | |
| | // of transaction while Thread B |

| | |
|---|---|
| processes | // first request (conflict |

| | |
|---|---|
| causes abort) | |
| if (status == DONE) | // check that Thread B has |
| | completed |

// processing request

| | |
|---|---|
| XEND; | // yes, end transaction region and |

commit

| | |
|---|---|
| goto send_next; | // and send next request |

else

| | XABORT; | // no, force abort |
|---|---|---|
| handle_abort: | | // transaction abort |
| | while (status == NOT_DONE) | // polling loop for Thread B |
| | { }; | completion |
| | if (status == ERROR) | |

| | |
|---|---|
| error_handler( ); | // if error, handle it |

| | produce_request(request2); | // otherwise produce second |
|---|---|---|
| | | request |
| send_next: | | |
| | status = NOT_DONE; | |
| | send_request(request2, | // send second request |
| | &status); | |

| | |
|---|---|
| ... | |
| // Thread B (CPU 2) | |
| process_request(request); | // process the request |
| if (!error) | // and update status |

status = DONE;

else

status = ERROR;

An additional illustration of pseudo-code for thread A and thread B consistent with another exemplary embodiment is shown below. In this example, thread A (on CPU 1) produces a first request (request 1) and initializes a status variable to a “not done” state and an error indication variable (err) to a “no error” state. The request 1 is sent to thread B along with a reference to (i.e., address of) the status variable and a reference to the error indication variable. Thread A then enters a transaction region with a specified transaction abort handler. This may be accomplished on some processors, for example, with an XBEGIN instruction. Thread A then reads the “err” variable with the instruction “temp=err.” This action causes the “err” variable to be included in the monitored region of the transaction (e.g., read-set and/or write-set). Thread A then performs additional processing which may include the production of a second request (request 2).

Meanwhile, thread B (on CPU 2), processes request 1 in parallel and sets the status variable to indicate either an “error” or a “done” state. Additionally, in the event of an error, thread B writes to the err variable with the instruction “err=ERROR,” which triggers an abort of the transaction region in thread A since the “err” variable was in a monitored region of the transaction. The abort rolls back any effects of the processing, for example effects associated with the production of request 2 in thread A and causes thread A to execute the abort handler code segment.

If, however, the error triggered transaction abort does not occur, then at a subsequent point in time, thread A checks the status variable to determine if thread B has completed request 1 by updating the status variable to “done.” This check may be performed, for example, when thread A has no further processing that can be performed until the result from request 1 is obtained, or it may be performed at any other suitable time. If the check indicates completion, thread A commits the transaction and exits the transaction region. The commit may be accomplished on some processors, for example, with an XEND instruction. After committing the transaction thread A proceeds to the code segment labeled “send_next,” where the status variable is reset to a “not done” state and the second request (request 2) is sent to thread B.

Alternatively, if the check does not indicate completion, thread A triggers an explicit abort of the transaction which rolls back any effects of the processing and causes execution of the abort handler code segment. The abort may be accomplished on some processors, for example, with an XABORT instruction. This explicit abort trigger is distinguished from the automatic abort that is potentially triggered by thread B, as described above, in connection with a memory access conflict over the “err” variable. The abort handler executes a polling loop which waits for thread B completion, either “done” status or “error” status. In the event of an error, an error handler may be called, otherwise a new request 2 may be generated which is then re-sent to thread B for processing.

| | |
|---|---|
| // Thread A (CPU 1) | |
| produce_request(request1); | // produce first request |
| status = NOT_DONE; | |
| err = NO_ERROR; | |
| send_request(request1, &status, | // send first request to Thread B |
| &err); | |
| XBEGIN(handle_abort); | // begin a transaction region |
| temp = err; | // mem read to abort immediately |
| | on |
| error | |
| if (temp != NO_ERROR) XABORT; | |
| produce_request(request2); | // produce second request under |
| protection | |
| | // of transaction while Thread B |

| | |
|---|---|
| processes | // first request (conflict |

| | |
|---|---|
| causes abort) | |
| if (status == DONE) | // check that Thread B has |
| | completed |

// processing request

| | |
|---|---|
| XEND; | // yes, end transaction region and |

commit

| | |
|---|---|
| goto send_next; | // and send next request |

else

| | XABORT; | // no, force abort |
|---|---|---|
| handle_abort: | | // transaction abort |
| | while (status == NOT_DONE) | // polling loop for Thread B |
| | { }; | completion |
| | if (status == ERROR) | |

| | |
|---|---|
| error_handler( ); | // if error, handle it |

| | produce_request(request2); | // otherwise produce second |
|---|---|---|
| | | request |
| send_next: | | |
| | status = NOT_DONE; | |
| | send_request(request2, | // send second request |
| | &status); | |

| | |
|---|---|
| ... | |
| // Thread B (CPU 2) | |
| process_request(request); | // process the request |
| if (!error) | // and update status |

status = DONE;

else {

| | |
|---|---|
| status = ERROR; | |
| err = ERROR; | // triggers abort on Thread A |

| | |
|---|---|
| } | (CPU 1) |

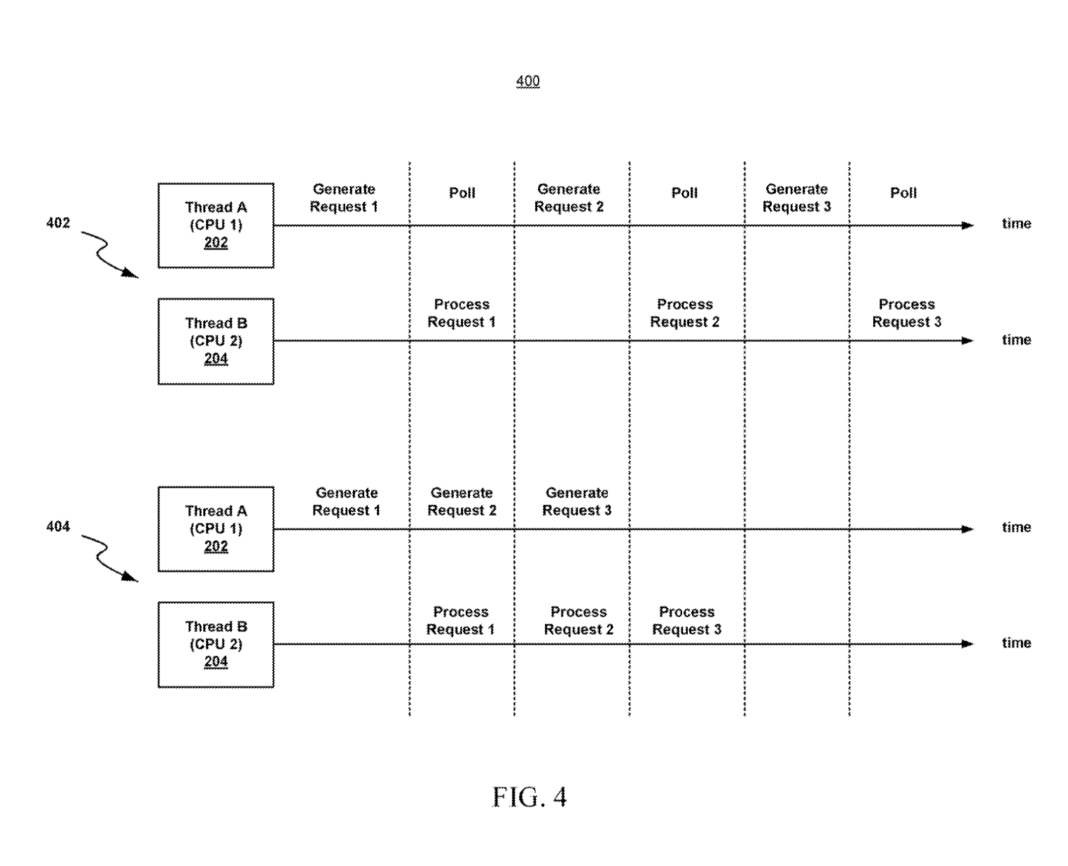

FIG. 4 illustrates a timing diagram 400 of one exemplary embodiment consistent with the present disclosure. Timeline 402 shows the interaction between thread A and thread B when polling is performed. Thread A generates request 1 and sends it to thread B for processing. While thread B is processing request 1, thread A consumes CPU cycles in a polling loop waiting for thread B to complete before moving on to generate request 2. In contrast, timeline 404 illustrates the effect of polling elision. In this case, thread A proceeds with the generation of request 2, or performs any other suitable type of processing, while thread B processes request 1 resulting in increased operational efficiency. Due to the use of RTM monitoring, as described above, any problems that may arise in the processing of requests by thread B can result in a roll back of subsequent processing effects by thread A, which may then fall back to a polling operation.

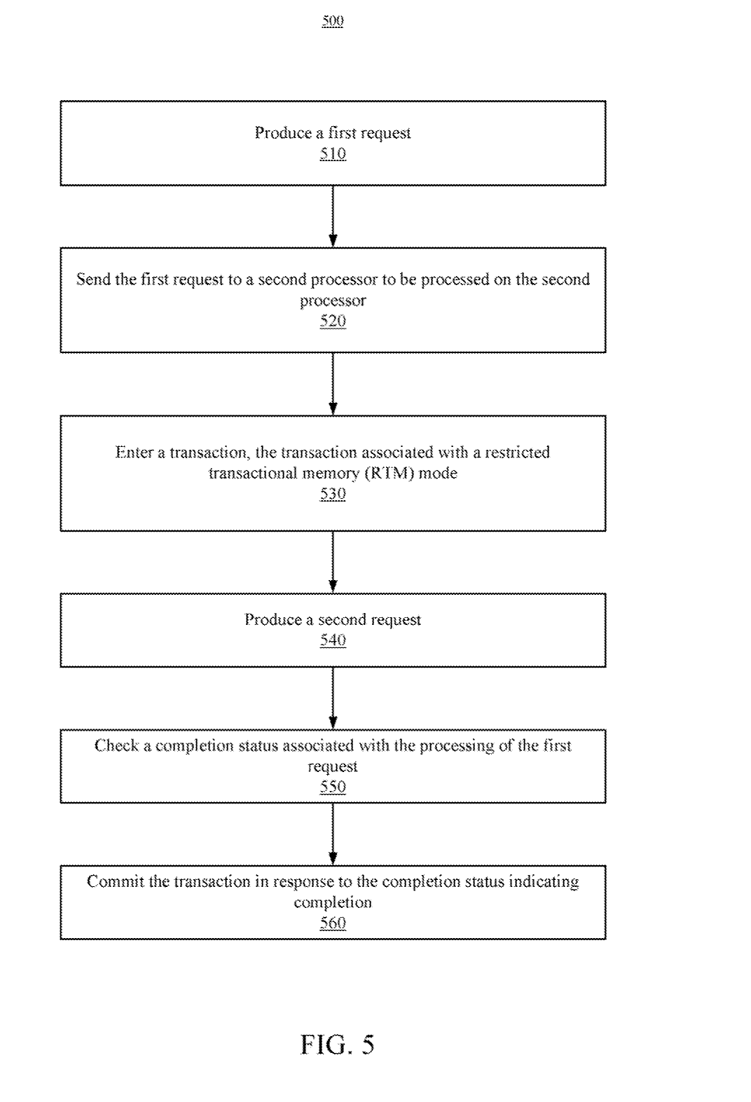

FIG. 5 illustrates a flowchart of operations 500 of another exemplary embodiment consistent with the present disclosure. The operations provide a method for software polling elision employing restricted transactional memory. At operation 510, a first request is produced. The first request is produced by a requesting thread on a first processor. At operation 520, the first request is sent to a second processor to be processed on the second processor. The request is processed by a processing thread on the second processor. At operation 530, a transaction is entered. The transaction is associated with an RTM mode. At operation 540, a second request is produced. The second request is produced by a requesting thread on the first processor. At operation 550, a completion status is checked. The completion status is associated with the processing of the first request on the second processor. At operation 560, the transaction is committed in response to the completion status indicating completion.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may include, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides systems, devices, methods and computer readable media for software polling elision with restricted transactional memory. The following examples pertain to further embodiments.

The device may include an RTM processor configured to monitor a region associated with a transaction and to enable an abort of the transaction, and the abort nullifies modifications to the region, the modifications associated with processing within the transaction prior to the abort. The device of this example may also include a code module configured to: produce a first request; send the first request to an external processing entity; enter the transaction; produce a second request; commit the transaction in response to a completion indication from the external processing entity; and abort the transaction in response to a non-completion indication from the external entity.

Another example device includes the forgoing components and the code module is further configured to send the second request to the external entity in response to the completion indication.

Another example device includes the forgoing components and the code module is further configured to poll for a completion indication from the external entity, in response to the abort.

Another example device includes the forgoing components and the code module is further configured to re-produce the second request and send the re-produced second request to the external entity, in response to completion of the polling.

Another example device includes the forgoing components and further includes a plurality of processing cores, and the code module is configured as a first thread executing on a first of the processing cores and the external entity is configured as a second thread executing on a second of the processing cores.

Another example device includes the forgoing components and the RTM is further configured to detect an access conflict to the monitored region and to abort the transaction in response to the detected conflict.

Another example device includes the forgoing components and the external entity is configured to write to a memory object associated with the monitored region in response to an error in the processing of the first request, and the writing triggers an abort of the transaction.

According to another aspect there is provided a method. The method may include producing a first request. The method of this example may also include sending the first request to a second processor to be processed on the second processor. The method of this example may further include entering a transaction, the transaction associated with an RTM mode. The method of this example may further include producing a second request. The method of this example may further include checking a completion status associated with the processing of the first request. The method of this example may further include committing the transaction in response to the completion status indicating completion.

Another example method includes the forgoing operations and further includes sending the second request to the second processor in response to the completion status indicating completion.

Another example method includes the forgoing operations and further includes, in response to the completion status indicating non-completion, aborting the transaction and polling the completion status for indication of completion.

Another example method includes the forgoing operations and further includes, in response to the polling indicating completion, re-producing the second request and sending the re-produced second request to the second processor.

Another example method includes the forgoing operations and the first processor and the second processor are processing cores.

Another example method includes the forgoing operations and further includes executing a first thread, by the first processor, to produce the first request and the second request; executing a second thread, by the second processor, to process the first request and the second request; and detecting, by the RTM, memory access conflicts between the first thread and the second thread.

Another example method includes the forgoing operations and further includes writing, by the second processor, to a memory object in response to an error in the processing of the first request, the memory object included in the transaction, and the writing triggers an abort of the transaction.

According to another aspect there is provided a system. The system may include a means for producing a first request. The system of this example may also include a means for sending the first request to a second processor to be processed on the second processor. The system of this example may further include a means for entering a transaction, the transaction associated with an RTM mode. The system of this example may further include a means for producing a second request. The system of this example may further include a means for checking a completion status associated with the processing of the first request. The system of this example may further include a means for committing the transaction in response to the completion status indicating completion.

Another example system includes the forgoing components and further includes a means for sending the second request to the second processor in response to the completion status indicating completion.

Another example system includes the forgoing components and further includes, in response to the completion status indicating non-completion, a means for aborting the transaction and a means for polling the completion status for indication of completion.

Another example system includes the forgoing components and further includes, in response to the polling indicating completion, a means for re-producing the second request and a means for sending the re-produced second request to the second processor.

Another example system includes the forgoing components and the first processor and the second processor are processing cores.

Another example system includes the forgoing components and further includes a means for executing a first thread, by the first processor, to produce the first request and the second request; a means for executing a second thread, by the second processor, to process the first request and the second request; and a means for detecting, by the RTM, memory access conflicts between the first thread and the second thread.

Another example system includes the forgoing components and further includes a means for writing, by the second processor, to a memory object in response to an error in the processing of the first request, the memory object included in the transaction, and the writing triggers an abort of the transaction.

According to another aspect there is provided at least one computer-readable storage medium having instructions stored thereon which when executed by a processor, cause the processor to perform the operations of the method as described in any of the examples above.

According to another aspect there is provided an apparatus including means to perform a method as described in any of the examples above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-21. (canceled)

22. A device for polling elision, said device comprising:
a restricted transactional memory (RTM) processor configured to monitor a region associated with a transaction and to enable an abort of said transaction, wherein said abort nullifies modifications to said region, said modifications associated with processing within said transaction prior to said abort; and
a code module configured to:
produce a first request;
send said first request to an external processing entity;
enter said transaction;
produce a second request;
commit said transaction in response to a completion indication from said external processing entity; and
abort said transaction in response to a non-completion indication from said external entity.

23. The device of claim 22, wherein said code module is further configured to send said second request to said external entity in response to said completion indication.

24. The device of claim 22, wherein said code module is further configured to poll for a completion indication from said external entity, in response to said abort.

25. The device of claim 24, wherein said code module is further configured to re-produce said second request and send said re-produced second request to said external entity, in response to completion of said polling.

26. The device of claim 22, further comprising a plurality of processing cores, wherein said code module is configured as a first thread executing on a first of said processing cores and said external entity is configured as a second thread executing on a second of said processing cores.

27. The device of claim 22, wherein said RTM is further configured to detect an access conflict to said monitored region and to abort said transaction in response to said detected conflict.

28. The device of claim 27, wherein said external entity is configured to write to a memory object associated with said monitored region in response to an error in said processing of said first request, wherein said writing triggers an abort of said transaction.

29. A method for polling elision on a first processor, said method comprising:
producing a first request;
sending said first request to a second processor to be processed on said second processor;
entering a transaction, said transaction associated with a restricted transactional memory (RTM) mode;
producing a second request;
checking a completion status associated with said processing of said first request; and
committing said transaction in response to said completion status indicating completion.

30. The method of claim 29, further comprising sending said second request to said second processor in response to said completion status indicating completion.

31. The method of claim 29, further comprising, in response to said completion status indicating non-completion:
aborting said transaction; and
polling said completion status for indication of completion.

32. The method of claim 31, further comprising, in response to said polling indicating completion:
re-producing said second request; and
sending said re-produced second request to said second processor.

33. The method of claim 29, wherein said first processor and said second processor are processing cores.

34. The method of claim 29, further comprising:
executing a first thread, by said first processor, to produce said first request and said second request;
executing a second thread, by said second processor, to process said first request and said second request; and
detecting, by said RTM, memory access conflicts between said first thread and said second thread.

35. The method of claim 29, further comprising writing, by said second processor, to a memory object in response to an error in said processing of said first request, said memory object included in said transaction, wherein said writing triggers an abort of said transaction.

36. A computer-readable storage medium having instructions stored thereon which when executed by a processor result in the following operations for polling elision, said operations comprising:
producing a first request;
sending said first request to a second processor to be processed on said second processor;
entering a transaction, said transaction associated with a restricted transactional memory (RTM) mode;
producing a second request;
checking a completion status associated with said processing of said first request; and
committing said transaction in response to said completion status indicating completion.

37. The computer-readable storage medium of claim 36, further comprising the operation of sending said second request to said second processor in response to said completion status indicating completion.

38. The computer-readable storage medium of claim 36, further comprising, in response to said completion status indicating non-completion, the operations of:
aborting said transaction; and
polling said completion status for indication of completion.

39. The computer-readable storage medium of claim 38, further comprising, in response to said polling indicating completion, the operations of:
re-producing said second request; and
sending said re-produced second request to said second processor.

40. The computer-readable storage medium of claim 36, wherein said first processor and said second processor are processing cores.

41. The computer-readable storage medium of claim 36, further comprising the operations of:
executing a first thread, by said first processor, to produce said first request and said second request;
executing a second thread, by said second processor, to process said first request and said second request; and
detecting, by said RTM, memory access conflicts between said first thread and said second thread.

42. The computer-readable storage medium of claim 36, further comprising the operation of writing, by said second processor, to a memory object in response to an error in said processing of said first request, said memory object included in said transaction, wherein said writing triggers an abort of said transaction.
